(19) United States
(12) Patent Application Publication
(10) Pub. No.: US 2026/0249510 A1
(43) Pub. Date: Aug. 27, 2026

(54) Chainsaw

(71) Applicant: Andreas Stihl AG & Co. KG, Waiblingen (DE)

(72) Inventors: Georg HEINZELMANN, Winnenden (DE); Martin FAILENSCHMID, Engstingen (DE); Daniel PADIAL, Korb (DE); Lukas DYTRYCH, Prague 4 (CZ)

(21) Appl. No.: 19/549,188

(22) Filed: Feb. 25, 2026

(30) Foreign Application Priority Data
Feb. 26, 2025 (DE) 10 2025 107 302.3
Feb. 26, 2025 (DE) 10 2025 107 306.6

(51) Int. Cl. B27B 17/02; B27B 17/08; B27B 17/00

(52) U.S. Cl. CPC B27B 17/02; B27B 17/083; B27B 17/0008

(57) ABSTRACT

A chainsaw includes a housing having a lower longitudinal edge region that connects a lower bottom surface of the housing to a lateral side surface of the housing, and a side sheet-metal part for shielding the housing at least in regions. The side sheet-metal part covers at least a section of the lower longitudinal edge region in such a manner that a bottom region of the side sheet-metal part extending at an angle to the lateral side surface runs substantially in a lateral continuation of the lower bottom surface.

### CROSS REFERENCE TO RELATED APPLICATIONS

This application claims priority under 35 U.S.C. §119 from German Patent Application Nos. 10 2025 107306.6, filed February 26, 2025 and 10 2025 107302.3, filed February 26, 2025, the entire disclosures of which are herein expressly incorporated by reference.

### BACKGROUND AND SUMMARY

The invention relates, in particular with several aspects of the invention in each case, to a chainsaw, in particular a motor-driven chainsaw.

An object of the present invention is to provide a chainsaw that has particular, in particular improved, properties. In particular, improved shielding of a region of a housing of the chainsaw against mechanical environmental influences is to be enabled.

This object is achieved by the subject matter of the independent patent claim. Preferred embodiments are the subject matter of the dependent patent claims. The wording of all patent claims is incorporated into the content of the present description by express reference.

The inventive aspects mentioned above and/or below may be implemented individually or in combination. A chainsaw according to one of the inventive aspects may, where appropriate, also be further configured according to another aspect of the invention. In particular, the aspects of the invention may be realized in the same chainsaw.

Embodiments of the invention - unless expressly stated in a conclusive manner or otherwise mutually exclusive - may in principle be derived from any one of the inventive aspects taken individually or from a combination of some or all of the inventive aspects. The same applies in particular to advantageous features.

A chainsaw according to a first aspect of the invention has a housing. The housing has a lower longitudinal edge region that connects a lower bottom surface of the housing to a lateral side surface of the housing. In particular, the longitudinal edge region extends substantially along a longitudinal direction of the chainsaw. The chainsaw further has a side sheet-metal part that is configured to shield the housing in regions, in particular mechanically. The side sheet-metal part may cover the housing in regions, in order to shield a covered region of the housing. The side sheet-metal part covers at least a section of the lower longitudinal edge region of the housing. In this case, at least the section of the lower longitudinal edge region is covered by means of the side sheet-metal part, in such a manner that a bottom region of the side sheet-metal part, extending at an angle to the lateral side surface, runs substantially in a lateral continuation of the lower bottom surface of the housing. The bottom region of the side sheet-metal part may be angled relative to the contact surface. The bottom region of the side sheet-metal part may be bent over toward the bottom surface around the longitudinal edge region. The bottom region of the side sheet-metal part may geometrically complete and/or functionally supplement the bottom surface of the housing in an edge-reinforcing manner.

In this way, the lower longitudinal edge region of the housing can be shielded at least in sections against external mechanical influences by means of the side sheet-metal part. This may be particularly advantageous if the housing has, in the lower longitudinal edge region, a housing material that is soft relative to the side sheet-metal part or is made of a housing material of this kind.

Advantageously, the housing material of the chainsaw may comprise or be a polymer material.

The expression “to extend substantially in lateral continuation” may be advantageously understood to mean “to extend substantially in a common alignment toward one side” and/or “to extend substantially flush,” in particular “to extend flush in surface alignment”. In this context, “substantially” may include an offset that may be present under certain circumstances but is not mandatory, for example in the form of a surface offset of up to 0.2 mm and/or an angular offset of up to 5°.

In an embodiment of the invention, in particular based at least on the first aspect of the invention, the side sheet-metal part has a contact surface for abutment of a saw chain guide bar for the chainsaw. The contact surface extends substantially parallel to the lateral side surface of the housing.

In a further embodiment of the invention, in particular based at least on the first aspect of the invention, the chainsaw has a support device. The support device defines a support plane, in particular of the chainsaw. In this case, the support device is configured to contact a substrate for the chainsaw in the support plane, in particular when the chainsaw is placed or set down on the substrate. A distance is present between the support plane and the bottom region of the side sheet-metal part. The distance may be at least 1 mm and/or at most 10 mm, in particular between 3 mm and 7 mm, more particularly approximately 5 mm. The distance may be measured perpendicularly away from the support plane.

Advantageously, the support device may comprise at least one support foot, for example two or more support feet, and/or at least one support rib. At least one support foot and/or at least one support rib may project from the lower bottom surface of the housing, in particular integrally.

In a further embodiment of the invention, in particular based at least on the first aspect of the invention, the side sheet-metal part has a collar section extending around an outer circumference. In particular, the collar section extends around an outer periphery of the side sheet-metal part and/or projects at an angle, in particular at a right angle, toward the housing relative to the contact surface. In this case, the collar section includes the bottom region of the side sheet-metal part. In other words, the bottom region of the side sheet-metal part may be a partial section of the collar section. The circumferential collar section may mechanically stiffen the side sheet-metal part. The collar section may border and/or frame a lateral side section of the housing.

In a further embodiment of the invention, in particular based at least on the first aspect of the invention, the side sheet-metal part has a transition region that extends longitudinally parallel to the lower longitudinal edge region of the side sheet-metal part. The side sheet-metal part further has a mounting region that comprises or forms the contact surface. The transition region of the side sheet-metal part connects the mounting region of the side sheet-metal part to the lower bottom region of the side sheet-metal part. In this case, the transition region is of rounded design, in particular at least on its outer side, more particularly on the side facing away from the housing. In particular, the transition region has at least one edge rounding with an outer radius of 1 mm to 10 mm. A transition region of this kind can counteract jamming of the chainsaw on the tree trunk during delimbing of a tree trunk using the chainsaw.

In a further embodiment of the invention, in particular based at least on the first aspect of the invention, the transition region of the side sheet-metal part has a substantially planar inclined surface region. The inclined surface region is configured for, in particular tangential, sliding movement along a tree trunk to be delimbed.

In a further embodiment of the invention, in particular based at least on the first aspect of the invention, an air gap is present in sections between the side sheet-metal part and the housing, the air gap measuring approximately 0.6 mm, in particular approximately 0.1 mm, measured perpendicularly to the contact surface. In particular, the air gap is present only in sections, more particularly so that the side sheet-metal part and the housing can contact one another without a gap in other regions.

In a further embodiment of the invention, in particular based at least on the first aspect of the invention, the side sheet-metal part is manufactured from sheet metal having a thickness of 0.2 mm to 0.5 mm, in particular 0.3 mm. Alternatively or in addition, the side sheet-metal part has a sheet-metal thickness of this kind, at least in certain regions. In particular, the sheet metal is a steel sheet or an aluminum sheet.

Advantageously, the side sheet-metal part may be formed monolithically.

In a further embodiment of the invention, in particular based at least on the first aspect of the invention, the lower longitudinal edge region of the housing has a groove. The groove may extend longitudinally along the longitudinal direction of the chainsaw. The groove of the lower longitudinal edge region is configured to receive the lower bottom region of the side sheet-metal part. In particular, the lower bottom region of the side sheet-metal part is at least partially received by the groove.

Advantageously, the groove may be configured to receive the bottom region of the side sheet-metal part substantially flush with a support surface. Where necessary, the bottom region of the side sheet-metal part may be received by the groove in a manner substantially flush with the support surface.

In a further embodiment of the invention, in particular based at least on the first aspect of the invention, the chainsaw has a machine width measured perpendicularly to the contact surface of the side sheet-metal part. In particular, the machine width is measured without a handle tube of the chainsaw, in particular with the handle tube of the chainsaw removed. The machine width may therefore be a handle-tube-free machine width. The side sheet-metal part has an extent measured parallel to the machine width. In this case, the extent of the side sheet-metal part measured parallel to the machine width is less than 50% of the machine width. In particular, the lower bottom region of the side sheet-metal part extends along the machine width and ends facing toward a longitudinal center plane of the chainsaw that bisects the machine width. In other words, the bottom region may project along the machine width toward the longitudinal center plane and/or end at a distance from the longitudinal center plane.

In a further embodiment of the invention, in particular based at least on the first aspect of the invention, the chainsaw has a chain-catcher section that projects away from the housing. The chain-catcher section is detachably fastened to the housing with the side sheet-metal part detachably secured therebetween. In particular, the chain-catcher section is detachably fastened to the housing by means of a screw connection of the chainsaw in such a manner that the side sheet-metal part is clamped between the chain-catcher section and the housing. The chain-catcher section serves in particular to catch, in particular by hooking, a saw chain that jumps off the saw-chain guide bar.

In particular, the side sheet-metal part may have an opening in the region of the chain-catcher section, through which components located behind the side sheet-metal part can project in order to enable force support. Alternatively, or in addition, it is contemplated in certain cases for the side sheet-metal part to be provided with another opening for other components, in particular for sealing these components relative to one another without involvement of the side sheet-metal part in the sealing.

In a further embodiment of the invention, in particular based at least on the first aspect of the invention, the housing carries a drive motor of the chainsaw, in particular an electric drive motor. The drive motor is configured to provide drive power for a saw chain that is guided in a circulating manner on the saw-chain guide bar. In this case, the side sheet-metal part has a through-hole for guiding a drive shaft of the drive motor therethrough. The drive shaft may carry and/or drive a drive sprocket for the saw chain.

In a further embodiment of the invention, in particular based at least on the first aspect of the invention, both the housing and the side sheet-metal part each have positioning aids for assembly positioning. The positioning aids of the housing and the positioning aids of the side sheet-metal part are complementary to one another. In particular, the positioning aids of the housing are formed by laterally projecting bolts, and the positioning aids of the side sheet-metal part are formed by bores, each for receiving one of the bolts. Two bolts of this kind and two bores of this kind may be provided.

Advantageously, the positioning aids of the housing may also be used for mounting the guide bar, which is provided with corresponding bores. The bolts are, in particular, threaded bolts. In particular, nuts may be screwed onto the threaded bolts, in order to clamp the saw-chain guide bar between the contact surface and a sprocket cover of the chainsaw.

In a further embodiment of the invention, in particular based at least on the first aspect of the invention, the saw-chain guide bar is mountable between the sprocket cover of the chainsaw and the contact surface of the side sheet-metal part. The sprocket cover is arranged at a distance from the support plane, wherein this distance between the sprocket cover and the support plane is 25 mm to 35 mm. In particular, in a state in which the chainsaw is placed on the ground, the distance is measured perpendicularly away from the support plane to the point of the sprocket cover that is closest to the support plane, in particular the lowermost point thereof.

A chainsaw according to a second aspect of the invention has a housing and a brake lever that is pivotably mounted relative to the housing. In particular, the brake lever can be pivoted for actuation. In particular, actuation of the brake lever can decelerate, in particular stop, a saw chain that is guided in a circulating manner on the saw-chain guide bar of the chainsaw. The chainsaw has a side sheet-metal part that is configured to shield the housing in sections. In this case, the side sheet-metal part has a contact surface for supporting the saw-chain guide bar of the chainsaw. The brake lever has a shielding contour. The side sheet-metal part has a shielding section. The shielding section of the side sheet-metal part and the shielding contour of the brake lever are complementary to one another. The shielding contour of the brake lever and the shielding section of the side sheet-metal part interact to shield the housing, in particular in the region of a bearing arrangement for mounting the brake lever relative to the housing.

Through the interaction of the shielding section and the shielding contour, an ingress of foreign bodies, in particular in the form of chips, into the bearing arrangement for mounting the brake lever can be counteracted. In particular, as a result of the interaction of the shielding section and the shielding contour, the bearing arrangement can be sealed at least in sections relative to an external environment of the chainsaw, in particular at least, or only, in a chip-tight manner.

Advantageously, the brake lever may be referred to synonymously as a chain brake lever.

Advantageously, the chainsaw has a support device, wherein the support device defines a support plane and is configured to contact a ground surface in the support plane.

Advantageously, the housing has an upper longitudinal edge region that extends along a longitudinal direction of the chainsaw and connects an upper top surface of the housing, which faces away from the support device, to a lateral side surface of the housing.

Advantageously, the brake lever projects away from the support device.

Advantageously, the brake lever is pivotably mounted relative to the top surface by means of the bearing arrangement about a pivot axis, wherein the pivot axis extends parallel to the support plane and perpendicular to the longitudinal direction of the chainsaw.

Advantageously, the contact surface of the side sheet-metal part extends substantially parallel to the lateral side surface of the housing.

In an embodiment of the invention, in particular based at least on the second aspect of the invention, the shielding section of the side sheet-metal part projects beyond an edge region of the side sheet-metal part, in particular in a tongue-like manner. Alternatively, or in addition, the shielding section of the side sheet-metal part may project beyond the upper longitudinal edge region of the housing, in particular in a tongue-like manner. In particular, the shielding section projects, in particular in a tongue-like manner and/or substantially parallel to the contact surface, beyond the collar section of the side sheet-metal part.

In a further embodiment of the invention, in particular based at least on the second aspect of the invention, the shielding contour of the brake lever extends in segments along an imaginary circular line concentric with the pivot axis of the brake lever. In this way, the shielding interaction between the shielding section and the shielding contour can be maintained over the entire pivoting range of the brake lever relative to the housing.

In a further embodiment of the invention, in particular based at least on the second aspect of the invention, the pivot axis of the brake lever extends between the top surface of the housing and the support device of the chainsaw.

In a further embodiment of the invention, the shielding section of the side sheet-metal part is slidably engaged with the shielding contour of the brake lever. In particular, the shielding section is slidably engaged with the shielding contour axially with respect to the pivot axis of the brake lever and/or not radially with respect to the pivot axis of the brake lever. In particular, the shielding section and the shielding contour may be in planar contact with one another.

In a further embodiment of the invention, in particular based at least on the second aspect of the invention, the shielding contour of the brake lever has a recessed receiving groove. The receiving groove may be recessed axially with respect to the pivot axis of the brake lever. The receiving groove receives the shielding section of the side sheet-metal part at least partially. Accordingly, at least a portion of the shielding section may project into the receiving groove, in particular axially with respect to the pivot axis of the brake lever. In particular, the shielding contour and the shielding section may interact in the manner of a labyrinth seal.

Advantageously, the shielding section of the side sheet-metal part has a flange section projecting radially outward with respect to the pivot axis of the brake lever, wherein the flange section bears against the shielding contour of the brake lever. In particular, the flange section bears against a groove bottom surface of the receiving groove of the shielding contour.

In a further embodiment of the invention, in particular based at least on the second aspect of the invention, the shielding contour of the brake lever has a contour collar section, wherein the contour collar section projects axially with respect to the pivot axis of the brake lever. In particular, the contour collar section forms a radially outer groove flank of the receiving groove of the shielding contour. In particular, the shielding section of the side sheet-metal part does not contact the outer groove flank. The side sheet-metal part has at least one edge-interrupting recess through which the contour collar section extends, in particular along the imaginary circular line concentric with the pivot axis of the brake lever. In particular, the side sheet-metal part has two such edge-interrupting recesses which flank the shielding section of the side sheet-metal part and through which the contour collar section extends.

In a further embodiment of the invention, in particular based at least on the second aspect of the invention, at least one lever section of the brake lever that integrally forms the shielding contour comprises a polymer material or is made of such a polymer material. It is contemplated for the entire brake lever to be formed from, or made of, a polymer material.

In a further embodiment of the invention, in particular based at least on the second aspect of the invention, the side sheet-metal part is manufactured from sheet metal having a thickness of 0.2 mm to 0.5 mm, in particular 0.3 mm. Alternatively, or in addition, the side sheet-metal part may have a sheet-metal thickness of this kind, at least in certain regions. The sheet metal may be a steel sheet or an aluminum sheet.

Further advantages and features of the invention result from the claims and from the following description of preferred exemplary embodiments of the invention, which are illustrated with reference to the drawings. Identical reference signs refer to identical, similar, or functionally identical components in this case.

It is understood that the features mentioned above and those still to be explained below may be used not only in the respective combinations indicated, but also in other combinations or individually, without departing from the scope of the present disclosure.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows, in a schematic side view, a stylized embodiment of a chainsaw according to the invention;

FIG. 2 shows, in a schematic side view, a detail of a further embodiment of the chainsaw;

FIG. 3 shows, in a schematic side view, a side sheet-metal part of the chainsaw according to FIG. 2;

FIG. 4 shows, in a schematic sectional view, the side sheet-metal part according to FIG. 3 along a section taken along section line A–A;

FIG. 5 shows, in a schematic bottom view, in particular an underside view, a detail of a further embodiment of the chainsaw according to the invention;

FIG. 6 shows, in a schematic sectional view, a detail of a further embodiment of the chainsaw according to the invention;

FIG. 7 shows, in a schematic sectional view, a detail of a further embodiment of the chainsaw according to the invention;

FIG. 8 shows, in a schematic side view, a detail of a further embodiment of the chainsaw according to the invention;

FIG. 9 shows, in a schematic side view, a detail of a further embodiment of the chainsaw according to the invention;

FIG. 10 shows, schematically in a perspective sectional view, a detail of a further embodiment of the chainsaw according to the invention;

FIG. 11 shows, in a schematic sectional view, a further embodiment of the chainsaw according to the invention; and

FIG. 12 shows, in a schematic side view, another example of a side sheet-metal part.

### DETAILED DESCRIPTION OF THE DRAWINGS

A hand-held working device 100 in the form of a chainsaw 1 has a housing 4. The housing 4 has a lower longitudinal edge region 5. The lower longitudinal edge region 5 extends, for example, along a longitudinal direction 11 of the chainsaw 1.

The housing 4 has, for example, a lower bottom surface 5A and a lateral side surface 6. The lower bottom surface 5A and the lateral side surface 6 are connected to one another by the lower longitudinal edge region 5 of the housing 4. The lower longitudinal edge region 5 may form a transition between the lateral side surface 6 and the bottom surface 5A. The lateral side surface 6 may extend substantially perpendicular to the bottom surface 5A. During hand-held operation of the chainsaw 1, the lateral side surface 6 is, in particular, oriented away from the user guiding the chainsaw 1.

The housing 4 further has, for example, an upper longitudinal edge region 12 extending along the longitudinal direction 11 of the chainsaw 1. The housing 4 also has an upper top surface 12A in the present case. The upper longitudinal edge region 12 connects the top surface 12A with the lateral side surface 6. The housing 4 may be formed in multiple parts.

The chainsaw 1 has a side sheet-metal part 7 for shielding the housing 4 in sections. For example, a front region of the housing 4 in the longitudinal direction 11 may be shielded by means of the side sheet-metal part 7. For example, the side sheet-metal part 7 adjoins the housing 4 in a width direction 81 of the chainsaw 1. The width direction 81 in this case extends perpendicularly to the longitudinal direction 11. The side surface 6 of the housing 4 is, for example, oriented substantially orthogonally to the width direction 81.

The side sheet-metal part 7 is manufactured, for example, from a sheet metal 27. The sheet metal 27 may have a sheet-metal thickness of at least 0.2 mm and/or at most 0.5 mm, for example 0.3 mm. Alternatively, or in addition, the side sheet-metal part 7 has a sheet-metal thickness 28 of this kind of at least 0.2 mm and/or at most 0.5 mm, in particular 0.3 mm. The sheet metal 27 may be a steel sheet or an aluminum sheet. The side sheet-metal part 7 may be a formed part, for example a deep-drawn part. The side sheet-metal part 7 is, for example, formed monolithically.

The side sheet-metal part 7 in the present case has a contact surface 8 which is configured for placing a saw-chain guide bar 50 for the chainsaw 1. The saw-chain guide bar 50 is configured to guide a saw chain 51 in a circulating manner. The contact surface 8 of the side sheet-metal part 7 extends substantially parallel to the lateral side surface 6 of the housing 4. In particular, the contact surface 8 is oriented orthogonally to the width direction 81.

The chainsaw 1 has, for example, a brake lever 13, the actuation of which enables the saw chain 51 to be decelerated, in particular stopped. The brake lever 13 is mounted in the present case so as to be pivotable relative to the housing 4.

For example, the brake lever 13 has a shielding contour 16, in particular an integral shielding contour. The side sheet-metal part 7 has a shielding section 18 that is complementary to the shielding contour 16 of the brake lever 13. In the present case, the shielding section 18 and the shielding contour 16 interact in such a manner that, together, they shield an interior of the housing 4 in sections, in particular in a manner that is resistant to chips lifted off by the saw chain 51.

For example, the chainsaw 1 has a bearing arrangement 14 by means of which the brake lever 13 is pivotably mounted relative to the top surface 12A about a pivot axis 15 extending parallel to the width direction 81 and perpendicular to the longitudinal direction 11. In the present case, the shielding contour 16 and the shielding section 18 interact in such a manner that they shield the bearing arrangement 14, in particular to inhibit ingress of chips from outside, in particular seal it, and in particular provide sealing thereof. In particular, “to seal” may be understood as “to provide shielding that is not gas-tight and/or not liquid-tight.”

The chainsaw 1 has, for example, a support device 2. The support device 2 defines a support plane 3 and is configured to contact a ground surface 400 in the support plane 3 when the chainsaw 1 is placed on the ground surface 400. The support plane 3 may extend parallel to the width direction 81 and/or parallel to the longitudinal direction 11. The support plane 3 may extend substantially parallel to the lower bottom surface 5A of the housing 4. Alternatively, or in addition, the lower bottom surface 5A may face toward the support plane 3 and/or be exposed.

The side sheet-metal part 7 has, for example, a bottom portion 10 that extends at an angle, in particular at a right angle, to the lateral side surface 6 and/or to the contact surface 8. For example, the side sheet-metal part 7 covers at least, in particular only, a section 9 of the lower longitudinal edge region 5 in such a manner that the bottom portion 10 of the side sheet-metal part 7 extends substantially in a lateral continuation of the lower bottom surface 5A of the housing 4. For example, the bottom portion 10 of the side sheet-metal part 7 may extend the lower bottom surface 5A of the housing 4 substantially parallel to the width direction 81.

For example, a distance 19 is present between the bottom portion 10 of the side sheet-metal part 7 and the support plane 3. The distance 19 may be at least 1 mm and/or at most 10 mm, for example approximately 5 mm. The distance 19 may correspond to a height of a support foot and/or a height of a support rib of the support device 2.

With respect to the width direction 81, a slot-like gap may, in some cases, be present between mutually facing edges of the bottom surface 5A of the housing 4 and the bottom portion 10 of the side sheet-metal part 7, the gap extending in particular along the longitudinal direction 11. Alternatively, the mutually facing edges of the bottom surface 5A and of the bottom portion 10 may be joined to one another in a substantially gap-free manner.

The side sheet-metal part 7 has, for example, an outer peripheral collar section 20 extending circumferentially, in particular extending substantially circumferentially. The term “substantially” may mean in this case that one or two edge-interrupting recesses 47 of the side sheet-metal part 7 may be provided in some cases. The angularly projecting bottom portion 10 of the side sheet-metal part 7, in particular projecting at a right angle, is, for example, a partial section of the collar section 20.

The side sheet-metal part 7 has, for example, a mounting region 22 that comprises or forms the contact surface 8. The side sheet-metal part 7 may further have a transition region 21 extending parallel to the lower longitudinal edge region 5 and connecting the mounting region 22 to the lower bottom portion 10 of the side sheet-metal part 7. In the present case, the transition region 21 has a rounded design on an outer side of the side sheet-metal part 7 facing away from the housing 4. An edge rounding 23 of the transition region 21 may have, for example, an outer radius 24 of at least 1 mm and/or at most 10 mm.

In the present case, the transition region 21 has a substantially planar inclined surface region 25. The inclined surface region 25 extends, for example, parallel to the longitudinal direction 11 and is oriented at an acute angle relative to the support plane 3 in this case. The inclined surface region 25 is intended for sliding engagement along an outer circumference of a tree trunk from which branches are to be removed using the chainsaw 1.

For example, an air gap 26 is present only in sections between the side sheet-metal part 7 and the housing 4 in this case. The air gap 26 may have a maximum extent of approximately 0.2 mm measured perpendicular to the contact surface 8.

The lower longitudinal edge region 5 of the housing 4 has, for example, a groove 29. The groove 29 extends, for example, along the longitudinal direction 11 and is recessed perpendicular to the longitudinal direction 11. The groove 29 may be a longitudinal groove of the longitudinal edge region 5. The groove 29 is used in the present case to receive the lower bottom portion 10 of the side sheet-metal part 7. It is contemplated that the bottom portion 10 is received in the groove 29 in a manner that is substantially flush with the support surface.

The chainsaw 1 has, for example, a sprocket cover 39. The saw-chain guide bar 50 is mountable, in particular detachably, between the sprocket cover 39 and the contact surface 8. A distance 40 may be present between the sprocket cover 39 and the support plane 3, the distance being in the present case from 25 mm to 35 mm.

The shielding section 18 of the side sheet-metal part 7 mentioned above projects, for example, beyond an edge region 7A of the side sheet-metal part 7. The collar section 20 may form the edge region 7A. In the present case, the shielding section 18 projects in a tongue-like manner beyond the upper longitudinal edge region 12 of the housing 4. In the assembled state of the side sheet-metal part 7, the edge region 7A and the upper longitudinal edge region 12 may extend substantially parallel to one another.

For example, the shielding contour 16 of the brake lever 13 extends in segments along an imaginary circular line 17, the circular line 17 being concentric with the pivot axis 15 of the brake lever 13.

The pivot axis 15 of the brake lever 13 extends in the present case between the top surface 12A of the housing 4 and the support device 2. Accordingly, the bearing arrangement 14 may be located at least partially inside the housing 4.

The shielding section 18 is, for example, arranged so as to slide against the shielding contour 16. In this context, no radial contact is present between the shielding section 18 and the shielding contour 16 with respect to the pivot axis 15, whereas contact between the shielding section 18 and the shielding contour 16 is present only axially. In particular, the shielding section 18 and the shielding contour 16 bear against one another in an axially surface-to-surface manner.

The shielding contour 16 has, for example, a receiving groove 41. The receiving groove 41 may be recessed axially with respect to the pivot axis 15. In this case, the receiving groove 41 receives the shielding section 18 at least partially.

The shielding section 18 may have a flange section 43 projecting radially outward with respect to the pivot axis 15. The flange section 43 may bear against the shielding contour 16. For example, the flange section 43 is seated in a surface-to-surface manner against a groove bottom surface 44 of the receiving groove 41 of the shielding contour 16.

The shielding contour 16 has, for example, a contour collar section 46. The contour collar section 46 may project axially with respect to the pivot axis 15. For example, the contour collar section 46 forms a radially outer groove flank 45 of the receiving groove 41. The groove flank 45 and the flange section 43 may be radially spaced apart from one another with respect to the pivot axis 15.

As already mentioned, the side sheet-metal part 7 may have at least one edge-interrupting recess 47. In the present case, the side sheet-metal part 7 has two edge-interrupting recesses 47 of this kind that flank the shielding section 18. In this case, the contour collar section 46 extends and/or is movable along the circular line 17 through the edge-interrupting recesses 47.

The shielding contour 16 may be an integral component of a lever section 48 of the brake lever 13. At least this lever section 48 has, in the present case, a polymer material, in particular a plastic material. It is contemplated that at least the lever section 48 of the brake lever 13 is made of a polymer material of this kind.

The chainsaw 1 has, for example, a handle-tube-free machine width 30. The machine width 30 may be measured along the width direction 81. The side sheet-metal part 7 may have an extent 31 measured parallel to the width direction 81 that is, for example, less than 50% of the machine width 30.

The chainsaw 1 has, for example, a longitudinal center plane 31A oriented orthogonally to the width direction 81. In the present case, the longitudinal center plane 31A bisects the machine width 30. The lower bottom portion 10 of the side sheet-metal part 7 extends, for example, in the width direction 81 toward the longitudinal center plane 31A, in particular without intersecting or contacting the longitudinal center plane 31A.

The chainsaw 1 has, for example, a chain-catcher section 32, on which the saw chain 51 that may jump off the saw-chain guide bar 50 in some cases can become caught.

The chain-catcher section 32 may be detachably fastened to the housing 4, for example by means of a screw connection 33. The side sheet-metal part 7 may be fastened between the chain-catcher section 32 and the housing 4, in particular by means of the screw connection 33. To this extent, the chain-catcher section 32 may perform a dual function by providing a catching function for the saw chain 51 jumping off the guide bar and, a washer-like fastening function for the side sheet-metal part 7.

The housing 4 carries, for example, a drive motor 34 of the chainsaw 1, in particular an electric drive motor. The drive motor 34 is designed to provide drive power for the saw chain 51 guided in a circulating manner on the saw-chain guide bar 50.

The side sheet-metal part 7 has, for example, a through-hole 35, through which a drive shaft 35A of the drive motor 34 is guided. If the saw chain 51 jumps off the saw-chain guide bar 50 toward the housing 4, the side sheet-metal part 7 can prevent contact between the saw chain 51 and the housing 4. In particular, the handle-tube-free machine width 30 may be measured in the region of the drive shaft 35A of the drive motor 34, in particular along a rotational axis of the drive shaft 35A.

For example, the drive power provided by means of the drive motor 34 may be based on electrical energy drawn from a battery pack 200. In this case, the chainsaw 1 may have a receiving device 49 designed to removably receive the battery pack 200 in a receiving direction 60. In conjunction with receiving the battery pack 200, an electrical connection of the battery pack 200 to the chainsaw 1 may be established. The inserted battery pack 200 may be removed from the receiving device 49 in a direction opposite to the receiving direction 60. The receiving direction 60 may extend at an angle, for example at a right angle or - as in the present case - at an acute angle, relative to the support plane 3 and/or parallel to the longitudinal center plane 31A. In the present case, the receiving direction 60 extends away from the saw-chain guide bar 50, so that the battery pack 200 can be inserted from the front upper side toward the rear lower side. The chainsaw 1, or the working device 100 formed by the chainsaw 1, may be operable by battery power.

The housing 4 has, for example, positioning aids 36A. The side sheet-metal part 7 may have complementary positioning aids 36B. The positioning aids 36A, 36B of the housing 4 and of the side sheet-metal part 7 may be matched to one another for relative positioning of the housing 4 and the side sheet-metal part 7 during assembly.

The positioning aids 36A of the housing 4 may be formed by laterally projecting bolts 37, in particular two bolts and/or bolts arranged spaced apart from one another in the longitudinal direction 11, whereas the positioning aids 36B of the side sheet-metal part 7 are formed by bores 38, each configured to receive one of the bolts 37.

The positioning aids 36A of the housing 4 may also serve, for example, to mount the saw-chain guide bar 50 provided with corresponding bores. The bolts 37 are, for example, threaded bolts. For example, nuts 370 may be screwed onto the threaded bolts, in order to clamp the saw-chain guide bar 50 detachably between the contact surface 8 and the sprocket cover 39. The nuts 370 may bear against the sprocket cover 39 in this case.

In its state mounted on the chainsaw 1, the saw-chain guide bar 50 may extend substantially in the longitudinal direction 11 and/or substantially parallel to the longitudinal center plane 31A.

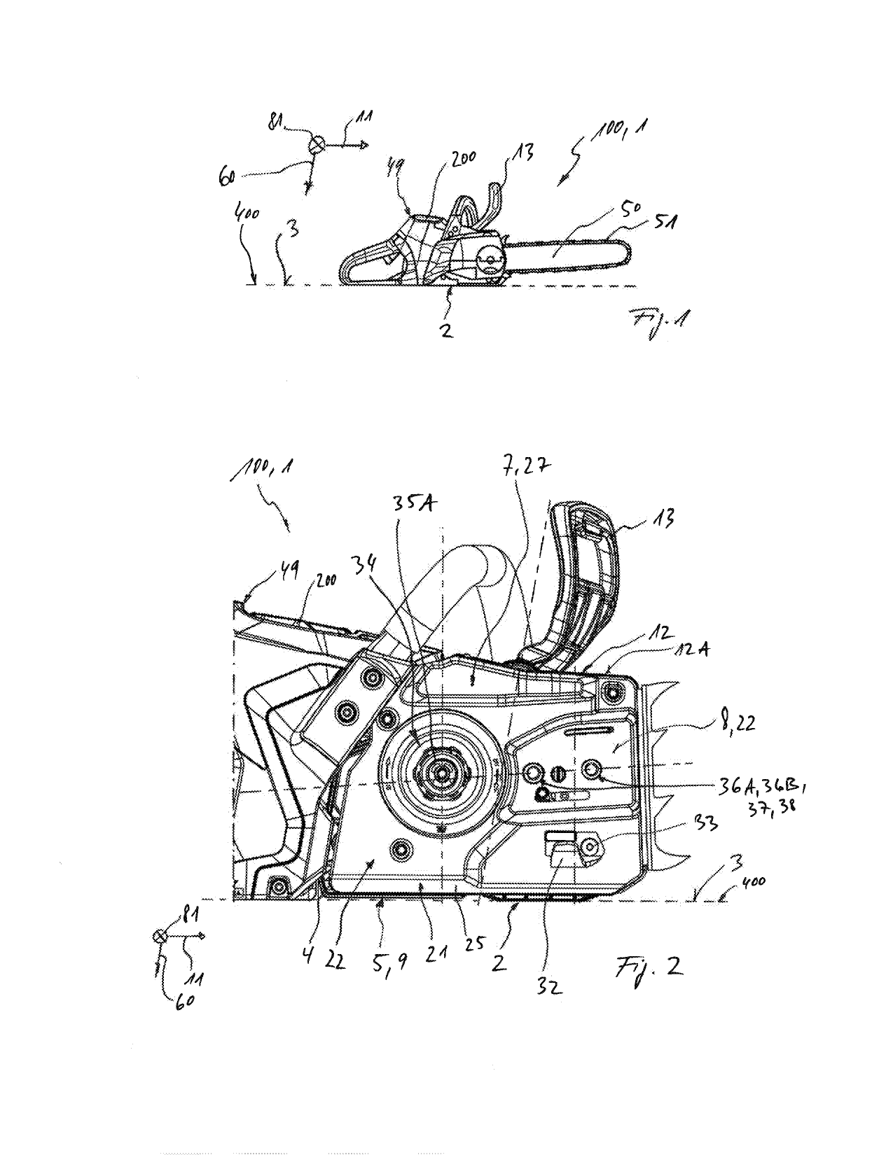

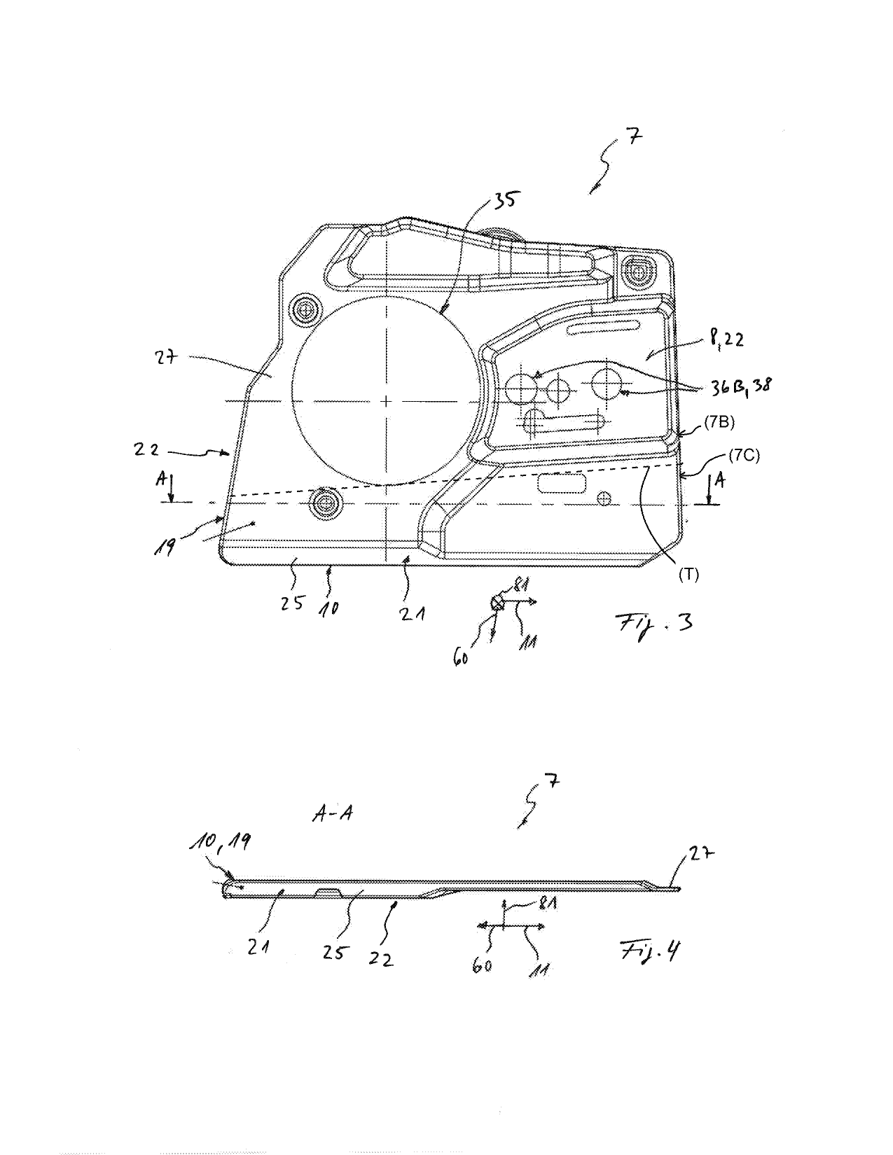

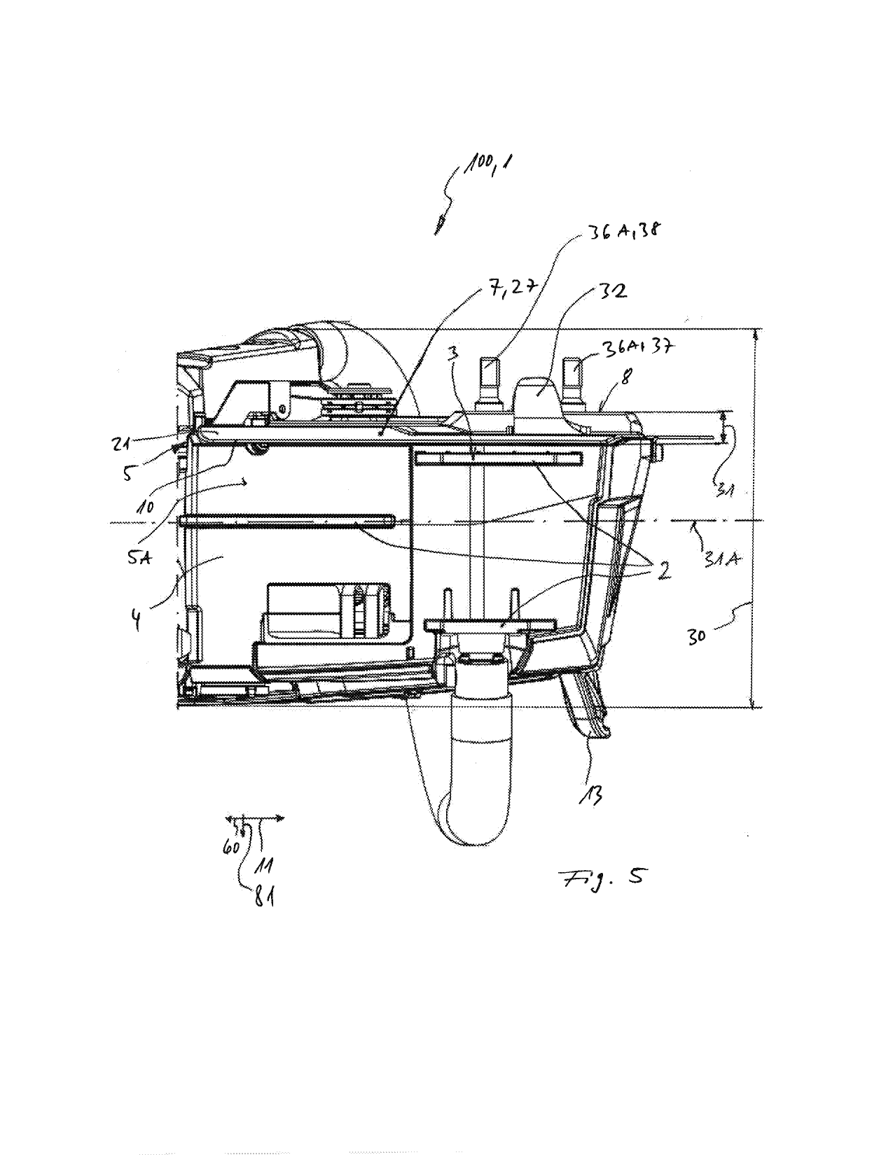

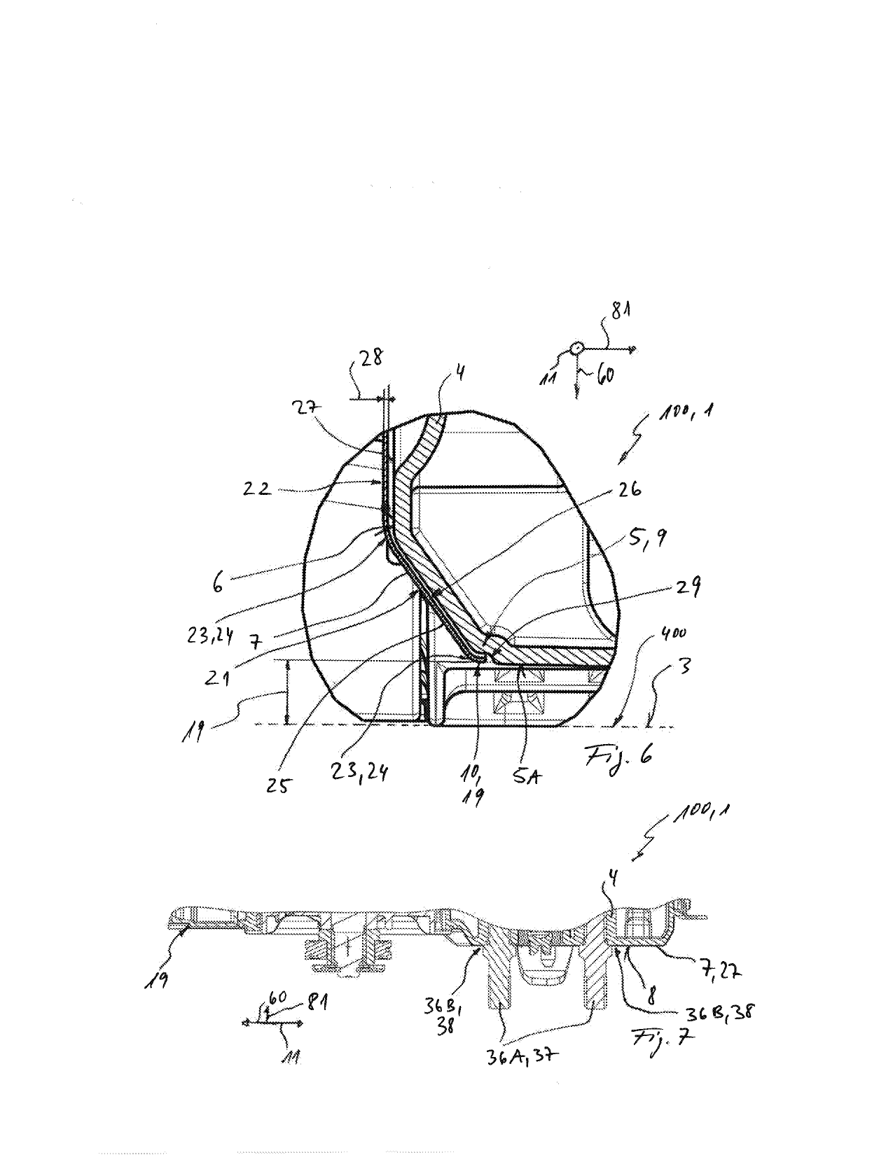

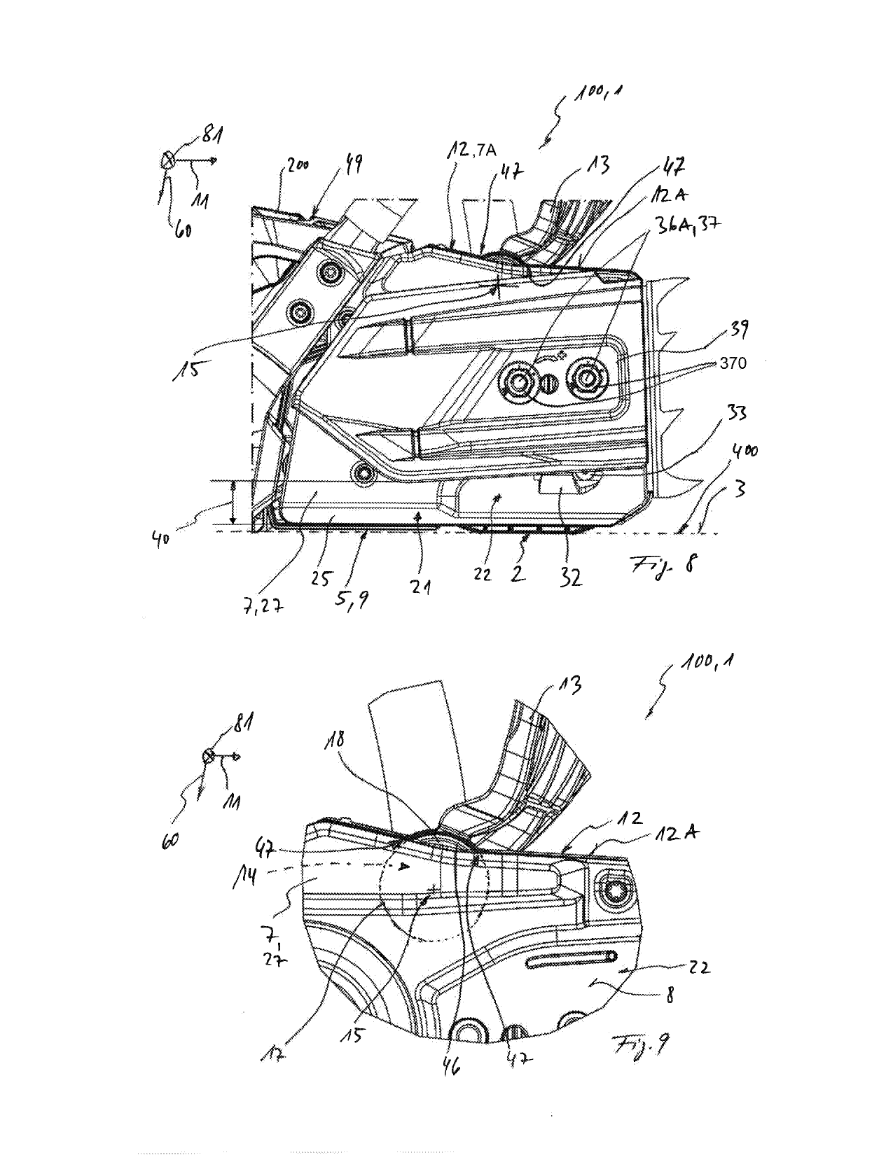

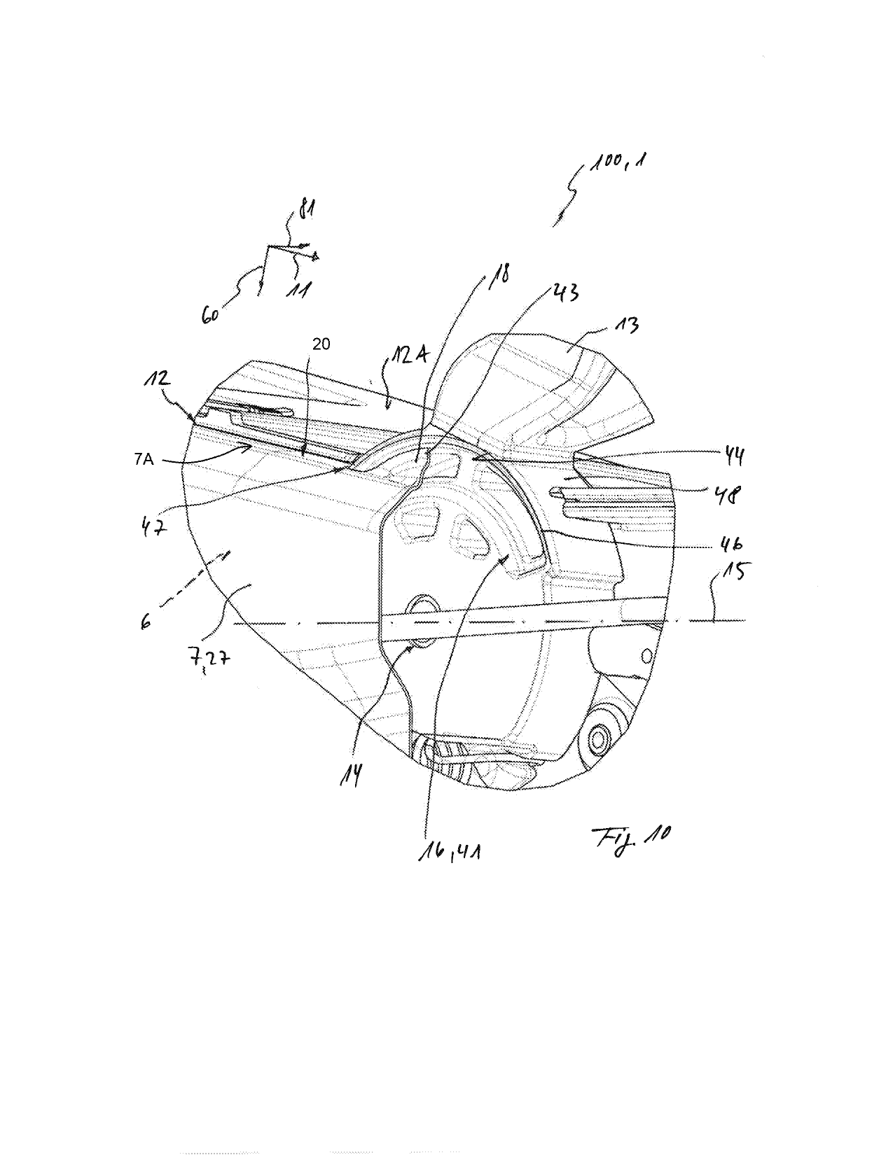

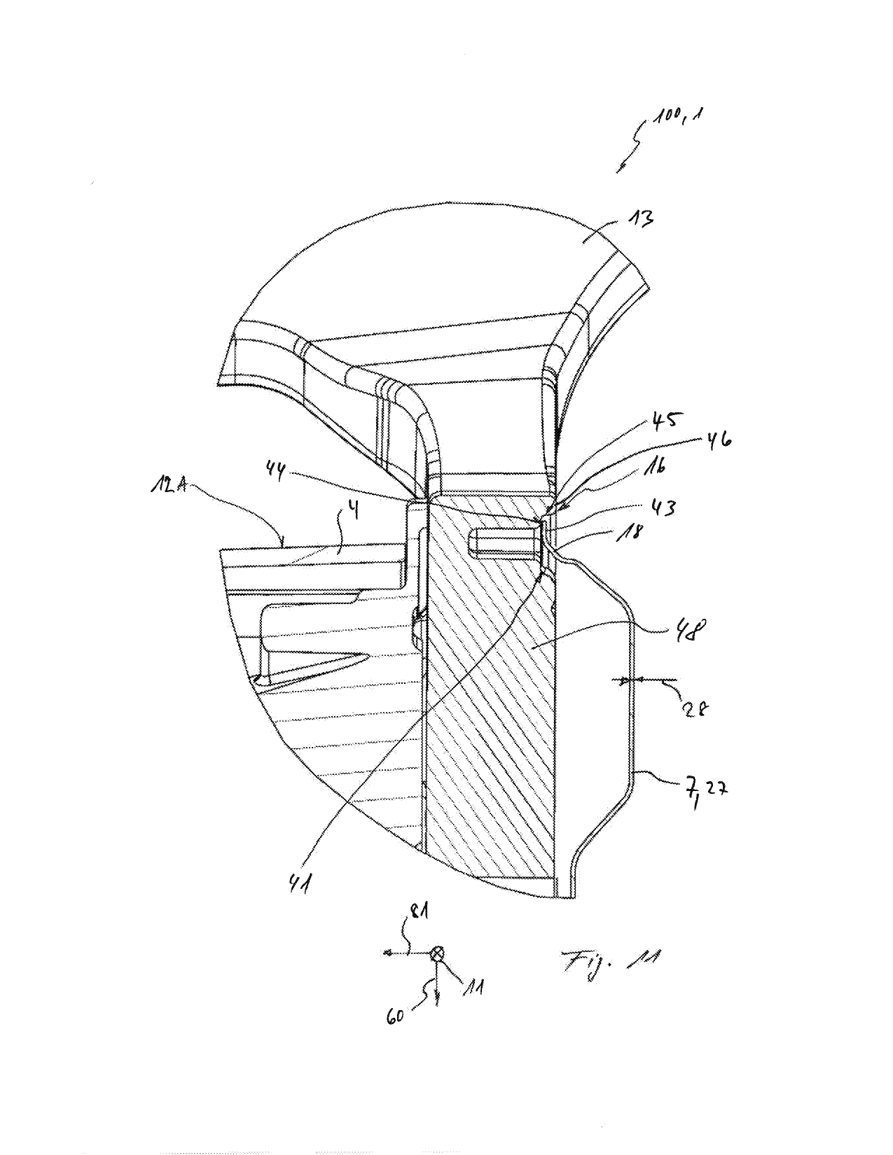

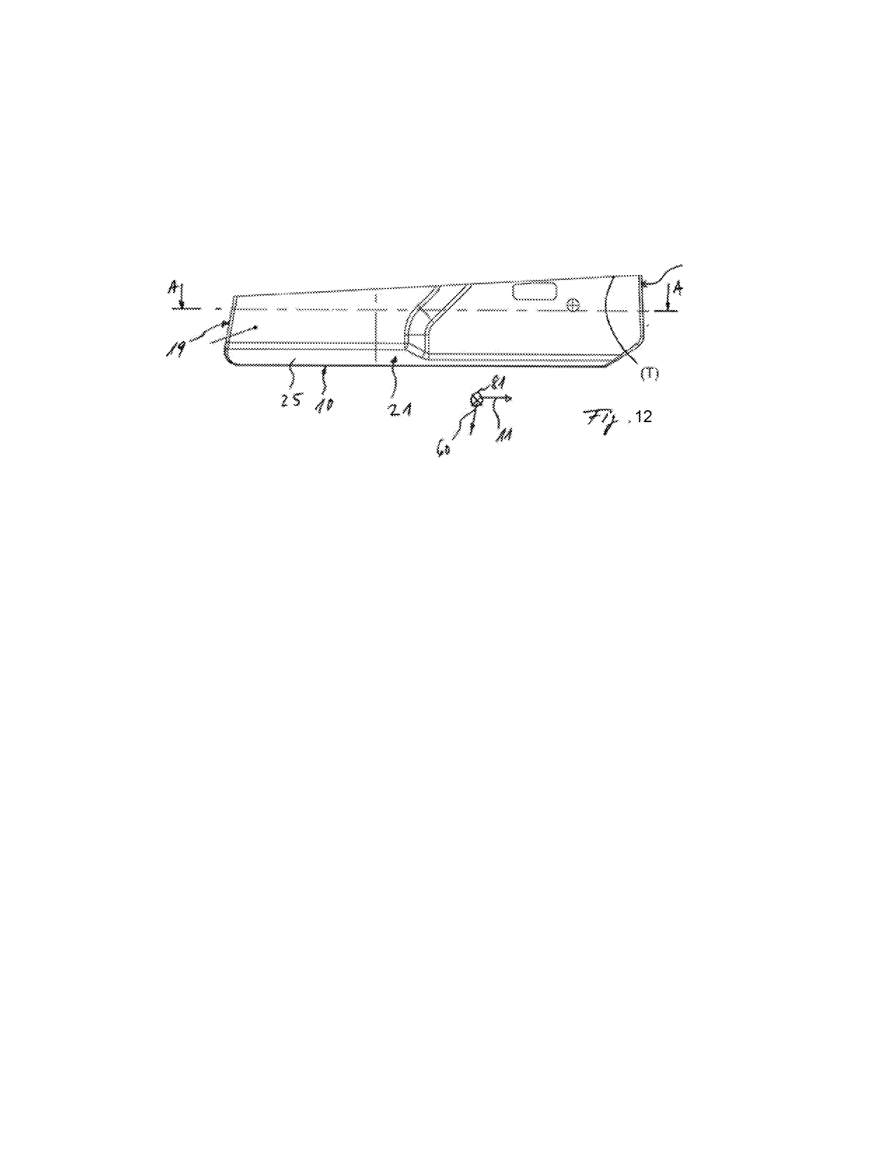

The illustrations in FIGS. 1 to 11 may relate to the same embodiment of the chainsaw 1. In particular, the details shown may be details of a single working device 100 in the form of the chainsaw 1.

In an alternative embodiment, illustrated by the bracketed reference signs shown in FIG. 3, the above-described function of the side sheet-metal part 7 may be divided between two separate sheet-metal parts 7B, 7C. A first of the sheet-metal parts 7B may be a mounting sheet-metal part in this case having the contact surface 8, while a second of the sheet-metal parts 7C functions as a lower housing edge cover. In this case, an edge of the side sheet-metal part 7 and/or an edge of the mounting sheet-metal part 7B may extend along a separation line T. Under certain circumstances, one of the sheet-metal parts 7B, 7C may be omitted, in particular if only one of the inventive aspects is to be implemented.

FIG. 12 shows separately, by way of example, the sheet-metal part 7B which may in some cases be used alone as the side sheet-metal part 7, in particular for implementing only the first inventive aspect by means of this sheet-metal part 7B or side sheet-metal part 7.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A chainsaw, comprising:
a housing having a lower longitudinal edge region that connects a lower bottom surface of the housing to a lateral side surface of the housing; and
a side sheet-metal part for shielding the housing at least in regions,
wherein the side sheet-metal part covers at least a section of the lower longitudinal edge region such that a bottom region of the side sheet-metal part extending at an angle to the lateral side surface runs substantially in a lateral continuation of the lower bottom surface.

2. The chainsaw according to claim 1,
wherein the side sheet-metal part has a contact surface extending substantially parallel to the lateral side surface, for placing a saw-chain guide bar for the chainsaw.

3. The chainsaw according to claim 1, further comprising:
a support which defines a support plane and is configured to contact a support surface in the support plane,
wherein a distance is present between the support plane and the bottom region of the side sheet-metal part.

4. The chainsaw according to claim 1,
wherein the side sheet-metal part has a circumferential collar section extending around an outer periphery,
wherein the collar section includes the bottom region of the side sheet-metal part.

5. The chainsaw according to claim 1,
wherein a transition region of the side sheet-metal part extending longitudinally parallel to the lower longitudinal edge region connects a mounting region of the side sheet-metal part, which includes or forms the contact surface, to the lower bottom region,
wherein the transition region has a rounded design, at least on an outer side, and
wherein the transition region has at least one edge rounding with an outer radius of 1 mm to 10 mm.

6. The chainsaw according to claim 1,
wherein a transition region of the side sheet-metal part connecting a mounting region of the side sheet-metal part to the lower bottom region has a substantially planar inclined surface region for sliding along a tree trunk to be de-limbed.

7. The chainsaw according to claim 1,
wherein an air gap is present between the side sheet-metal part and the housing, the air gap measuring approximately 0.2 mm perpendicular to a contact surface of the chainsaw.

8. The chainsaw according to claim 1,
wherein the side sheet-metal part is of sheet metal having a sheet thickness of 0.2 mm to 0.5 mm at least in certain regions.

9. The chainsaw according to claim 1,
wherein the lower longitudinal edge region of the housing has a groove for receiving the lower bottom region of the side sheet-metal part.

10. The chainsaw according to claim 1,
wherein the chainsaw has a machine width measured perpendicularly to a contact surface of the chainsaw,
wherein an extent of the side sheet-metal part measured parallel to the machine width is less than 50% of the machine width,
wherein the lower bottom region extends along the machine width and ends facing toward a longitudinal center plane of the chainsaw that bisects the machine width.

11. The chainsaw according to claim 1, further comprising:
a chain-catcher section projecting away from the housing, which is detachably fastened to the housing, by a screw connection, while detachably fastening the side sheet-metal part.

12. The chainsaw according to claim 1,
wherein the housing carries a drive motor of the chainsaw, which is configured to provide drive power for a saw chain that is guided in a circulating manner on a saw-chain guide bar,
wherein the side sheet-metal part has a through-opening for passing through an output shaft of the drive motor.

13. The chainsaw according to claim 1, further comprising:
a sprocket cover, between which socket cover and a contact surface of the chainsaw a saw-chain guide bar is mountable,
wherein a distance measured between the sprocket cover and the support plane of 25 mm to 35 mm is present.

14. A chainsaw, comprising:
a housing;
a brake lever which is pivotably mounted relative to the housing; and
a side sheet-metal part for shielding the housing at least in regions, wherein the side sheet-metal part has a contact surface for placing a saw-chain guide bar for the chainsaw,
wherein the brake lever has a shielding contour,
wherein the side sheet-metal part has a shielding section,
wherein the shielding section of the side sheet-metal part and the shielding contour of the brake lever are matched to one another in a complementary manner and interact to shield the housing.

15. The chainsaw according to claim 14,
wherein the shielding section of the side sheet-metal part projects beyond an edge region of the side sheet-metal part.

16. The chainsaw according to claim 14,
wherein the shielding contour of the brake lever extends in segments along an imaginary circular line concentric with a pivot axis of the brake lever.

17. The chainsaw according to claim 14,
wherein the shielding section is slidably engaged with the shielding contour axially with respect to the pivot axis of the brake lever and/or not radially with respect to the pivot axis of the brake lever, in planar contact with one another.

18. The chainsaw according to claim 14,
wherein the shielding contour has a receiving groove recessed axially with respect to a pivot axis of the brake lever,
wherein the receiving groove receives the shielding section at least partially.

19. The chainsaw according to claim 14,
wherein the shielding contour has a contour collar section projecting axially with respect to a pivot axis of the brake lever and forming a radially outer groove flank of a receiving groove of the shielding contour,
wherein the side sheet-metal part has two edge-interrupting recesses which flank the shielding section, through which the contour collar section extends, along a circular line.

20. A chainsaw, comprising:
a housing having a lower longitudinal edge region which connects a lower bottom surface of the housing to a lateral side surface of the housing;
a brake lever which is pivotably mounted relative to the housing; and
a side sheet-metal part for shielding the housing at least in regions, wherein the side sheet-metal part has a contact surface for placing a saw-chain guide bar for the chainsaw,
wherein the side sheet-metal part covers at least one section of the lower longitudinal edge region such that a bottom region of the side sheet-metal part, which extends at an angle to the lateral side surface, extends substantially in a lateral continuation of the lower bottom surface,
wherein the brake lever has a shielding contour,
wherein the side sheet-metal part has a shielding section,
wherein the shielding section of the side sheet-metal part and the shielding contour of the brake lever are matched to one another in a complementary manner and interact to shield the housing.
